(19) United States
(12) Patent Application Publication
(10) Pub. No.: US 2005/0027688 A1
(43) Pub. Date: Feb. 3, 2005

(54) Gateway for efficiently identifying an end user's local service provider

(75) Inventors: Paul Joseph Brady, Windsor, CT (US); Gary F. Sagnella, East Haven, CT (US); Elias Berelian, Stratford, CT (US); Lesley A. Baker, Hamden, CT (US)

Correspondence Address: GREENBLUM & BERNSTEIN, P.L.C., 1950 ROLAND CLARKE PLACE, RESTON, VA, 20191, US

(73) Assignee: SBC Knowledge Ventures L.P., Reno, NV (US)

(21) Appl. No.: 10/628,211

(22) Filed: Jul. 29, 2003

(51) Int. Cl. G06F 7/00

(52) U.S. Cl. 707/3

(57) ABSTRACT

A subscriber's local service provider is identified in response to a telephone call from a subscriber to a called party. When a request is received from a customer for the identity of the subscriber's local service provider, a first determination is made as to which line information database to query. Then, it is determined what message type to send to the identified line information database. Subsequently, a query is launched to the line information database, and when a response is received, a response is forwarded to the customer.

### BACKGROUND OF THE INVENTION

1. Field of the Invention

The present invention is related to facilitating billing within a telecommunications environment. More particularly, the present invention relates to efficiently identifying an end user's local service provider.

2. Acronyms

The written description contains acronyms that refer to various telecommunications services, components and techniques, as well as features relating to the present invention. Although some of these acronyms are known, use of these acronyms is not strictly standardized in the art. For purposes of the written description, acronyms will be defined as follows:
Account Owner (AO)
Advanced Intelligent Network (AIN)
Billed Number Screening (BNS)
Billing Service Provider (BSP)
Identification (ID)
Integrated Services Digital Network User Part (ISUP)
Internet Protocol (IP)
Interexchange Carrier (IXC)
Initial Address Messages (IAMs)
Line Information Database (LIDB)
LIDB Access Routing Guide (LARG)
Local Exchange Routing Guide (LERG)
Local Number Portability (LNP)
Local Service Provider (LSP)
Location Routing Number (LRN)
Number Pooling (NP)
Originating Line Number Screening (OLNS)
Public Switched Telephone Network (PSTN)
Revenue Accounting Office (RAO)
Service Control Point (SCP)
Service Switching Point (SSP)
Signaling System 7 (SS7)
Telecommunications Service Provider (TSP)
Telephone Number (TN)
Transactional Capabilities Application Part (TCAP)
Virtual Private Network (VPN)

3. Background and Material Information

Changes in the telecommunications environment have made it challenging for telecommunications service providers (TSPs) to identify an end user's local service provider (LSP). These changes, which included local number portability (LNP), number pooling (NP), and casual calling have made conventional methods of identifying LSPs unreliable. The correct identity of the LSP is needed to enable proper billing and collections. Current estimates indicate that the industry has lost in excess of $1 billion as a result of lost billing for not knowing the end user's LSP.

For example, an interexchange carrier (IXC), or an agent of the IXC, uses the Local Exchange Routing Guide (LERG) from Telcordia Technologies, Inc. to identify the LSP for settlement purposes. However, if the originating telephone number (TN) has been resold to another LSP, then a Return Code 50 reject message is returned to the IXC informing the IXC that the presumed LSP does not service a particular end user (ie., subscriber or caller). The identity of the new LSP will not be known to the IXC, as the LERG will still identify the original LSP as the owner of record. As a result, the IXC may attempt to identify and bill the end user's new LSP, or the end user may be billed. However, settlement may prove too costly or may be impossible, especially after several billing cycles have lapsed.

Therefore, it would be advantageous to efficiently and reliably identify the end user's LSP for recovering revenues that might otherwise be lost. Furthermore, it would be desirable to provide access to a nationwide collection of data that includes accurate LSP information in a manner using the most economical access method available.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is an exemplary telecommunication network, according to an aspect of the present invention;

FIG. 2 is an exemplary flow diagram, according to an aspect of the present invention; and

FIG. 3 is an exemplary call flow diagram, according to an aspect of the present invention.

### DETAILED DESCRIPTION OF EMBODIMENTS

The present invention relates to determining a caller's LSP, so that the LSP may be billed. In the following description, the term customer is used interchangeably with IXC and the term caller is used interchangeably with the terms end user and/or subscriber.

In view of the above, the present invention through one or more of its various aspects and/or embodiments is presented to accomplish one or more objectives and advantages, such as those noted below.

One aspect of the present invention is to provide a method of identifying a subscriber's local service provider in response to a telephone call from the subscriber to a called party. The method includes receiving a request from a customer for the identity of the subscriber's local service provider, determining which of multiple databases to query, determining a message type to send to the database selected in response to the first determination, and launching a query to the selected database.

The method may also include determining the message type based upon a cost associated with each of the available message types. Further, the determining of the message type may be based upon the message type supported by each of the databases, which include line information databases. Then, a response is received from the selected database that was queried, and after formatting, a response is sent to the customer.

Launching a query to one of the databases may occur prior to the telephone call being connected to the called party, during the pendency of the telephone call, or after the telephone call has been disconnected.

According to another aspect of the present invention, a method is provided of identifying a subscriber's local service provider in response to a telephone call from the subscriber to a called party. The method includes receiving a request from a customer for the identity of the subscriber's local service provider, determining a message type in which to query a database based at least on a cost associated with each of multiple message types, and launching a query to one of the databases based upon the determination.

The method may also include determining the message type based upon the message type supported by each of the databases, which include line information databases. When a response is received from the queried database, it is formatted, and sent to the customer.

Launching a query to one of the databases may occur prior to the telephone call being connected to the called party, during the pendency of the telephone call, or after the telephone call has been disconnected.

In another aspect of the present invention, a system is provided for identifying a subscriber's local service provider associated with a telephone call from the subscriber to a called party. The system includes a gateway that receives a request from a customer to ascertain the identity of the subscriber's local service provider. The gateway is able to determine one of available message types in which to query one of multiple databases, which may include line information databases.

The gateway may determine the message type based upon a cost associated with each available message type. Further, the gateway may determine the message type based upon a message type supported by each of the databases.

The request from the customer may be received prior to the telephone call being connected to the called party, during the pendency of the telephone call, or after the telephone call has been disconnected.

According to another aspect of the present invention, a computer readable medium is provided for identifying a subscriber's local service provider in response to a telephone call from the subscriber to a called party. The computer readable medium includes a receiving source code segment that receives a request from a customer for the identity of the subscriber's local service provider, a determining source code segment that determines a message type to query a database based on a cost associated with multiple message types, and a launching source code segment that launches a query to one of multiple databases, which may include line information databases.

The present invention helps solve the problem of lost revenue experienced by a customer (i.e., IXC) as a result of a Return Code 50 reject message indicating that an LSP does not service, or no longer services, an end user's account. That is, the IXC may now request, and expect to receive the identity of an end user's LSP. Upon receiving a customer's request, the provider (ie., gateway provider) may efficiently process the IXC's request, reliably returning the identity of the end user's LSP to the IXC. As will be shown, a gateway is implemented by the provider to receive requests from IXCs, query for and receive the requested information, and send the results to the IXC.

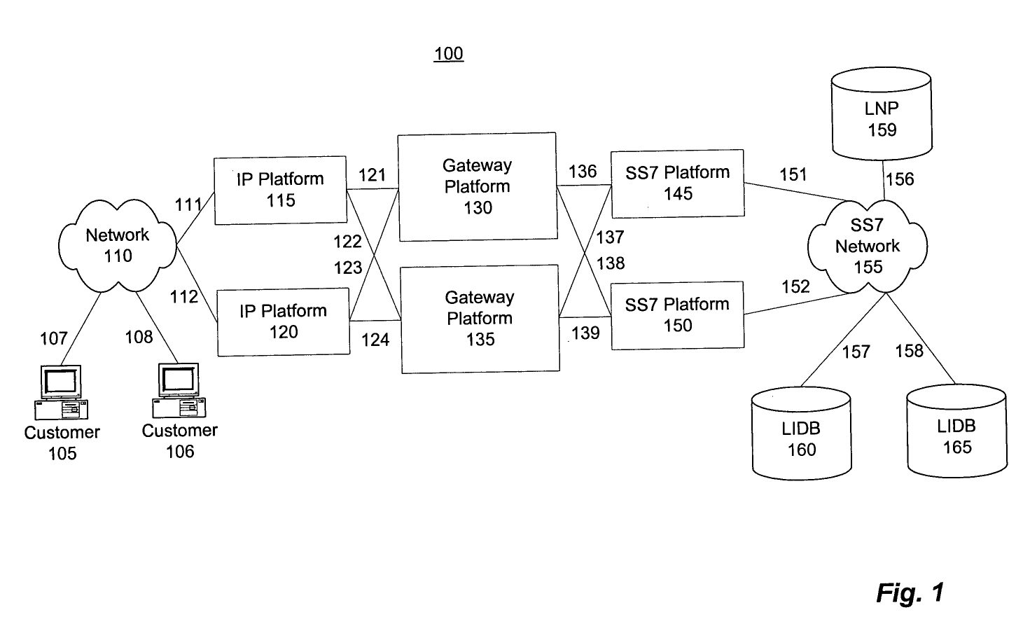

FIG. 1 shows an exemplary telecommunications network, according to an aspect of the present invention. The network 100 includes customers 105, 106, a network 110, IP platforms 115, 120, gateway platforms 130, 135, SS7 platforms 145, 150, an SS7 network 155, an LNP database 159 and LIDBs 160, 165. Of course, the number of elements depicted in the exemplary illustration are representative in nature and in practice, additional customers, networks, gateway platforms, LIDBs, etc. may be supported. Although the LNP database 159 and LIDBs 160, 165 are referred to within, suitable alternatives may be substituted without departing from the spirit of the present invention.

The customers 105, 106 include, for example, IXCs and access the network 110 via data links 107 and 108. The network 110 includes any appropriate network by which the customers 105, 106 may communicate with the IP platforms 115, 120, through data links 111, 112, including packet-switched networks such as the Internet. Alternatively, the customers 105, 106 may communicate with the IP platforms 115, 120 via a direct link The gateway platforms 130, 135 may reside at any suitable location including distinct central office facilities. Further, various firewalls and/or routers (not shown) may be included in the telecommunications network in a known manner. Each of the LIDBs 160, 165 represent one of the various LIDBs located across North America.

Each of the customers 105, 106 includes a processor running a Windows-based application (i.e., customer application) that is coded in the C++ programming language, and which maintains transport control protocol/internet protocol (TCP/IP) connections to the IP platforms 115, 120. The customer application reads in requests from an input file or a communications port from another platform and sends the requests to the IP platform 115 or to the IP platform 120. A response that the customer application receives from the IP platform 115 or the IP platform 120 is written to an output file or to a communications port. The customer application exchanges heartbeat messages with the IP platforms 115, 120 to verify connections thereto. In one embodiment, requests sent by the customer application alternate between the IP platform 115 and the IP platform 120. In any event, the customer application monitors the status of the connections to the IP platforms 115, 120 so that in the event that one connection is lost, the requests may proceed without interruption to the other IP platform. Further, in the event that one connection is lost, the customer application seeks to reestablish the connection with the lost IP platform. The customer processor also runs, for instance, the Securemote or SecureClient software, available from Check Point Software Technologies, Ltd. for encryption and for a VPN connection to a provider firewall. It is understood that the invention is designed to work with a variety of customer applications and is not limited to the one discussed herein.

In the following discussion, although reference may be made to only one customer or network elements, it is understood that others are supported by the invention. In one embodiment, the customer 105 makes a TCP/IP connection to an application residing on the IP platform 120 (i.e., IP application), which is coded in the C++ programming language and operates on, for example, the Windows 2000 Professional platform. The IP application controls IP connections and transmits and receives requests and responses (as will be discussed later) over one of a plurality of RS232 interfaces 121, 122, 123, 124 that connect the IP platforms 115, 120 to and from one of the gateway platforms 130, 135.

The gateway platforms 130, 135 dynamically load share request volumes such that requests are distributed between the gateway platforms 130, 135, ensuring that one platform does not become overloaded. For instance, in the event of a compromise at the gateway platform 130, request traffic is automatically redirected to the gateway platform 135, until the obstacle is remedied.

At each of the gateway platforms 130, 135, a processor operating a software application (i.e., gateway software) coded in the C++ programming language and operating, for example, the Windows 2000 Professional platform receives requests from the customer 105 and transmits queries to one of the LIDBs 160, 165. Also, each of the gateway platforms 130, 135 receives responses from the LIDBs 160, 165 and sends the responses to the customers 105, 106 through one of the IP platforms 115, 120 over one of the plurality of RS232 interfaces 121, 122, 123, 124. Specifically, the gateway software on each gateway platform 130, 135 translates an ASCII text format request received from the customers 105, 106 into an SS7 format query for transmission to one of the LIDBs 160, 165. The gateway software sends a query to the LNP database 159 over the SS7 network 155 via one of the SS7 platforms 145, 150 to determine the appropriate LIDB to query, based upon the caller's telephone number. In one embodiment, the LIDB Access Routing Guide (LARG) from Telcordia Technologies, Inc. may also be used to determine the appropriate LIDB 160, 165 to query.

Further, the gateway software determines the message type in which to send the query to the LIDBs 160, 165. That is, the data gateway software maintains a lookup table, which specifies the most economical available (i.e., least cost) query to send to each LIDB 160, 165. For example, a GetData query may be less expensive to send than an Originating Line Number Screening (OLNS) query. Also, the gateway software maintains the number of queries processed, which may be used for billing purposes. After translating the ASCII text format request into an appropriate SS7 format query, the gateway software transmits the SS7 message query via TCP/IP to one of the SS7 platforms 145, 150 over one of a plurality of TCP/IP links 136, 137, 138, 139.

The SS7 platforms 145, 150 dynamically load share query volumes such that queries are distributed between the SS7 platforms 145, 150, ensuring that one platform does not become overloaded. In the event of a compromise at the SS7 platform 145, query traffic is automatically redirected to the SS7 platform 150, until the problem is rectified. Exemplary SS7 platforms include SS7 boards and applications available from Performance Technologies, Inc., which serve as the access point into the SS7 network using SS7 connections 151, 152 and to signal transfer points (STPs) (not shown) using SS7 links.

In an alternative embodiment, the processor at the gateway platforms 130, 135 operate a software application coded in the C programming language on an MS-DOS platform. In any event, the functionality of the MS-DOS application is identical to the Windows-based application. That is, the gateway software translates an ASCII text format request received from the customer 105 into an SS7 format query for transmission to one of the LIDBs 160, 165, determines the message type in which to send to the selected LIDB and maintains the number of queries processed. After translating the ASCII text format request into an appropriate SS7 format query, the gateway software transmits the SS7 query via a low-level ethernet connection 136, 137, 138, 139 to one of the SS7 platforms 145, 150. In this embodiment, exemplary SS7 platforms include a PCTP processor available from Tekelec of Calabasas, Calif., which serves as an access point into the SS7 network using SS7 connections 151, 152 and to STPs (not shown) using SS7 links.

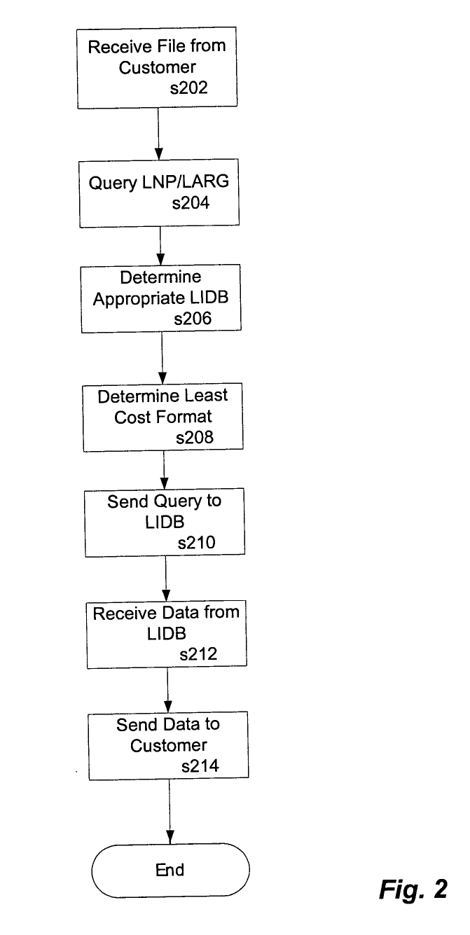

FIG. 2 is an exemplary flow diagram, according to an aspect of the present invention. At step s202, the provider receives a query (i.e., a request) in ASCII text format from the customer 105 requesting an identification of the LSP servicing a telephone call made by a caller. An exemplary file sent from the customer 105 to the provider will be discussed hereinafter. At step s204, the gateway software sends a query to an LNP database 159 to determine the appropriate LIDB 160, 165 to query, based upon the caller's telephone number. In one embodiment, the LARG may also be used to determine the appropriate LIDB 160, 165 to query. At step s206, the appropriate LIDB 160, 165 is identified and is returned to the gateway software by the LNP 159 and/or is identified by the LARG and is returned to the gateway software. At step s208, a determination is made as to the particular format (i.e., message type) in which to query the LIDB 160, 165. That is, some LIDBs support only certain formats or an agreement made by the provider, for instance, may dictate the type of query that may be sent to each LIDB 160, 165. Further, if a particular LIDB 160, 165 supports more than one format, then the software will determine which format is most economical (i.e., least cost) to use. That is, the data gateway software maintains a lookup table, which specifies the least cost available query to send to each LIDB 160, 165. Optionally, the customer 105 may specify the particular message type that they desire, or request information applicable only to one message type (as will be discussed later). Accordingly, no lookup will be performed in these cases.

At step s210, a query is sent to the selected LIDB 160, 165 by the gateway software via one of the SS7 platforms 145, 150 and the SS7 network 155 to identify the LSP servicing the call. At step s212, a response is received from the LIDB 160, which indicates, when available, the revenue accounting office (RAO), account owner (AO), and billing service provider (BSP) associated with the originating telephone number. Then, at step s214, the response is sent to the customer 105, who may use the information to bill the LSP, establish a billing relationship if none exists, or choose to block that LSPs future calls from traversing its network. The response is returned to the customer 105, for instance, via the same mode of transmission and format as the original request. The various message types used to query the LIDBs 160, 165 will now be discussed.

Queries sent from the customers 105, 106 to the gateway platforms 130, 135 are sent in ASCII text format with a control character delimiter between queries. An exemplary query contains seven fields as is shown and discussed in the following example below:

SQ01 Q02022100000001 XXXXXXXX7149921111

In the exemplary query, the message type “SQ” occupies the first two positions. Message types other than “SQ” will be discussed hereinafter. Following the message type is a version number, “01” in the example. The next field contains either a “Q” for query or an “R” for response; a “Q” is shown in the example. A six digit date in yymmdd format occupies the next field, e.g., “020221”. After the date, an eight digit transaction number field is provided, which is used to correlate responses to queries, especially when queries are sent in real-time (i.e., query by query, rather than in batches). In this case, the transaction number is “00000001”. However, if the queries are not sent in real-time, the eight digit transaction number may be set to a default such as “00000000”, for example. Next, an eight digit customer identification (ID) is included, which identifies the IXC, e.g., “XXXXXXXX”. Lastly, a line number is provided that identifies the particular line number of the originating telephone call, e.g., “7149921111”. It is noted that more or fewer fields may be included and that the various fields may be longer or shorter than that shown in the exemplary embodiment.

Responses sent by the gateway platforms 130, 135 are also sent in ASCII text format and contain twelve fields as shown and discussed in the following example:

GD01R0202210000001XXXXXXXX7149921111,000,251031014,782,9740,0782

In the exemplary response, the message type field occupies the first two positions of the string. In this case, “GD” occupies the message type field; however, message types other than “GD” will be discussed hereinafter. Following the message type is a version number, “01” in the example. The next field contains either a “Q” for query or an “R” for response; an “R” is shown in the example. A six digit date in yymmdd format occupies the next field, e g., “020221”. After the date, an eight digit transaction number field is provided, which is used to correlate responses to queries, particularly when queries are sent in real-time. In this case, the transaction number is “00000001”. However, if the queries are not sent in real-time, the eight digit transaction number may be set to a default such as “00000000”, for example. Next, an eight digit customer identification (ID) is included, which identifies the IXC, e.g., “XXXXXXXX”. A ten-digit line number is also provided to identify the particular line number of the originating telephone call, e.g., “7149921111”.

In addition, responses contain a comma separated sequence of fields occupied by the information associated with the LSP. In the example shown above, a Reply Code “000”, a point code “251031014” corresponding to the sending LIDB, an RAO “782”, an AO “9740”, and a BSP “0782” occupy those respective fields. In the event of an error, an RAO, AO, and BSP will not be returned from the LIDB. Timeouts in which no response is received or format errors in which no query could be sent will not be returned with a point code, RAO, AO, and BSP. It is noted that more or less fields may be included and that the various fields may be longer or shorter than shown in the exemplary embodiment.

The message type field indicates the type of query made as shown in Table 1 below. For instance, an “SQ” in the message field indicates that the IXC wants to know the RAO, AO, and BSP, but does not know the message type to send to receive that information. In this case, the provider queries the LNP database 159 and/or the LARG to determine which LIDB to query, and then selects between a GetData query, OLNS query, and Billed Number Screening (BNS) query message type, depending upon an agreement between the provider and the identified LIDB. As a result, the query sent by the provider to the LIDB 160, 165 would have a “GD”, “OL”, or “BN” (see Table 1) in the message type field; and would appear in the response message type, depending upon the message type selected for transmission by the provider. In the event that a format error exists in the query to the gateway platforms 130, 135, then the response message type would be “SQ”, rather than “GD”, “OL”, or “BN”. Additionally, where a format error for an unknown LIDB exists with respect to an “SQ” query, a “!!” will be the response message type (see Table 2 below).

Table 1 below illustrates the following message types and the specific information returned:

TABLE 1

| Message Type | Return Information |
|---|---|
| SQ—SS7 query | RAO, AO, BSP |
| GD—GetData query | RAO, AO, BSP |
| OL—Originating Line Number Screening (OLNS) | RAO, AO, BSP |
| query | |
| BN—Billed Number Screening (BNS) query | RAO, AO, BSP |

Table 2 below illustrates exemplary reply codes that may occupy the Reply Code field (as discussed in the earlier example) and the meaning of each:

TABLE 2

000 - Normal “Return Result” from LIDB
001 - Timeout
002 - UDTS 0 - No translation for address of such nature
003 - UDTS 1 - No translation for this specific address
004 - UDTS 2 - Subsystem congestion
005 - UDTS 3 - Subsystem failure
006 - UDTS 4 - Unequipped user
007 - UDTS 5 - Network failure
008 - UDTS 6 - Network congestion
009 - UDTS (other)
010 - LIDB Error x01 - Unexpected component sequence
011 - LIDB Error x02 - Unexpected data value
012 - LIDB Error x03 - Unavailable network resource
013 - LIDB Error x04 - Missing customer record
014 - LIDB Error x06 - Data unavailable
015 - LIDB Error xFA - Screened response
016 - LIDB Error xFB - Misroute
017 - LIDB Error xFC - Missing group
018 - LIDB Error xFD - Vacant group
019 - LIDB Error xFE - Non-participating group
020 - LIDB other return error
021 - LIDB Return Reject
022 - Format Error: Invalid Query Length
023 - Format Error: Invalid Header (message type, version, query/
response fields)
024 - Format Error: Unrecognized Customer ID
025 - Format Error: Invalid characters in number field
026 - Format Error: Unknown LIDB

A response may be sent by the LIDB 160, 165 that has valid data in certain fields, but an error code in certain other fields (e.g., if a LIDB 160, 165 does not have a value for a particular field). In one embodiment, the Reply Code will return “000” and other fields will contain no data. In an alternate embodiment, the Reply Code will be “000”; however, some of the remaining fields may have an ampersand followed by a two letter error code in place of the field value. Specifically, Table 3 lists the field-specific error codes and the meaning of each:

TABLE 3

&DU—data unavailable
&SD—screened data
&IT—invalid tag
&PE—internal processing error (within LIDB)

In the aforementioned embodiment, the invention may be practiced on a post-call basis. That is, the customer 105 forwards a request to the provider, in batches for instance, after one or more calls have taken place. For instance, batch files containing requests for the identities of LSPs for a bulk number of calls may be sent from the customer via TCP/IP using IKE encryption, to establish a VPN connection over the Internet.

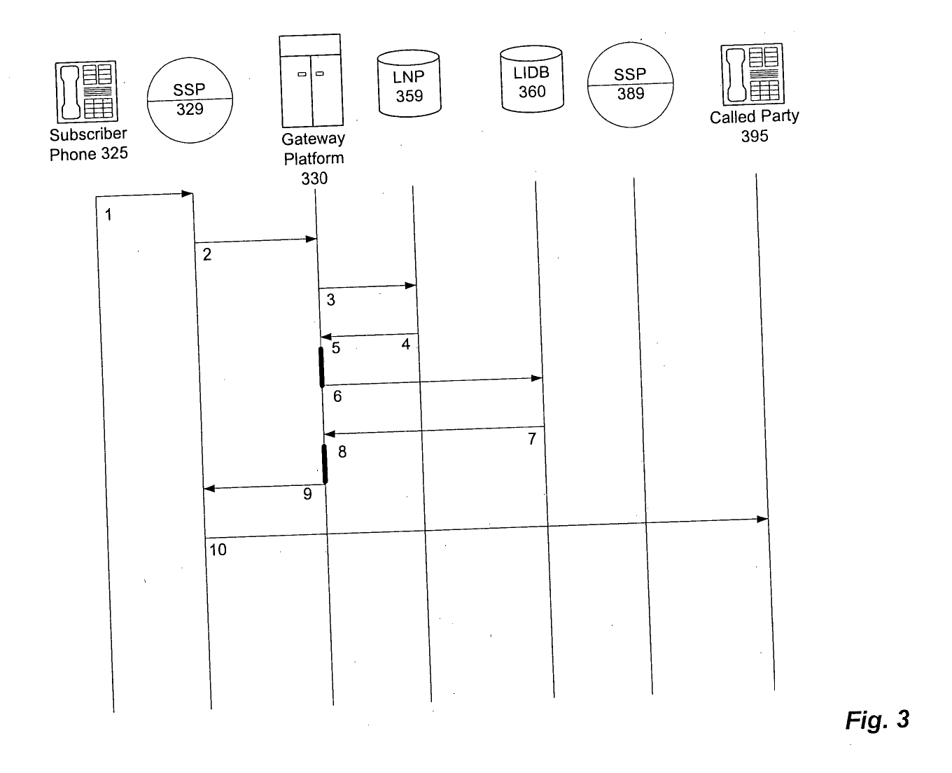

The invention may also be practiced on a real-time basis as will be discussed, for instance, with respect to FIG. 3. FIG. 3 is an exemplary call flow diagram according to an aspect of the present invention. The diagram includes a subscriber 325, an originating switch 329, a gateway platform 330, an LNP database 359, a LIDB 360, a terminating switch 389, and a called terminal 395.

At step 1, the subscriber 325 initiates a telephone call to the called terminal 395. At step 2, in one embodiment of the real-time process, the carrying IXC suspends the call at the switch (e.g, a service switching point (SSP)) 329, which sends a transactional capabilities application part (TCAP) query to the gateway platform 330 for processing. Alternatively, the gateway platform 330 sends the query to a service control point (SCP) for processing. In this regard, the invention may be practiced within the environment of the ubiquitous advanced intelligent network (AIN). Exemplary SSPs include, for example, 1AESS or 5ESS switches manufactured by Lucent Technologies, Inc.(Lucent); DMS-100 or DMS-250 switches manufactured by Nortel Networks Corporation (Nortel); AXE-10 switches manufactured by Telefonaktiebolaget LM Ericsson, or EWSD switches available from Siemens Information and Communication Networks, Inc. If the end offices include SSPs in an AIN environment, then the switches may utilize an AIN Release 0.2 protocol or a Carrier AIN (CAIN) protocol.

At step 3, the gateway software residing on the gateway platform 330 queries the LNP database 359 to determine the appropriate LIDB 360 to query based upon the caller's telephone number. As discussed previously, the LARG may also be used to determine the appropriate LIDB 360 to query. At step 4, the LNP database 359 provides an identification of the appropriate LIDB 360 to the gateway platform 330. At step 5, the gateway software determines the message type to query the LIDB 360. This determination is based upon the factors discussed previously with respect to FIGS. 1 and 2. At step 6, the gateway platform 330 sends a query to the LIDB 360 based upon the determination made in step 5. Then, at step 7 the LIDB 360 returns LSP information to the gateway platform 330. At step 8, the gateway platform 330 determines whether the LSP has a billing and collections agreement with the IXC. That is, the IXC may not wish to route the call if no billing and collections agreement exists with the LSP. Accordingly, at step 9, the gateway platform 330 forwards the LSP information, including whether a billing and collections agreement exists, to the IXC. Then, the IXC may route the call to the called terminal 395 through the terminating switch 389 at step 10. Otherwise, the IXC may choose not to route the call, at which time IXC disconnects the call before it is processed.

In still another embodiment, the invention may be practiced on a near real-time basis. That is, the provider monitors the carrier's integrated services digital network user part (ISUP) signaling traffic for initial address messages (IAMs) relating to casually dialed calls, for instance. For each casually dialed call, the gateway software residing on the gateway platform 330 queries the LNP database 359 to determine the appropriate LIDB 360 to query. As discussed previously, the LARG may also be used to determine the appropriate LIDB 360 to query. Then, the LNP database 359 identifies the appropriate LIDB 360 to the gateway platform 330. Next, the gateway platform 330 determines the message type in which to query the LIDB 360. This determination is based upon the factors discussed previously. As a result, the gateway software sends a query to the LIDB 360 based upon the determination of the message type. Then, the LIDB 360 returns the LSP information to the gateway software. Lastly, the gateway platform 330 forwards the LSP information to the IXC who may utilize the information for billing purposes.

Thus, the present invention efficiently and reliably identifies the end user's LSP. Moreover, the present invention acquires the information and provides it to the customer using the most economical access method available.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and includes art-recognized equivalents and successor media, in which the software implementations are stored.

Although the present specification describes components and functions implemented in the embodiments with reference to particular standards and protocols, the invention is not limited to such standards and protocols. Each of the standards for Internet and other packet-switched network transmission (e.g., TCP/IP) and public telephone networks (e.g., AIN, CAIN) represent examples of the state of the art. Such standards are periodically superseded by faster or more efficient equivalents having essentially the same functions. Accordingly, replacement standards and protocols having the same functions are considered equivalents

1. A method of identifying a subscriber's local service provider in response to a telephone call from the subscriber to a called party, the method comprising:
receiving a request from a customer for the identity of the subscriber's local service provider;
determining which of a plurality of databases to query;
determining a message type to send to the database selected in response to the first determination; and
launching a query to the selected database.

2. The method according to claim 1, wherein the determining of message type is based upon a cost associated with each of a plurality of available message types.

3. The method according to claim 1, wherein the determining of message type is based upon the message type supported by each of the plurality of databases.

4. The method according to claim 1, further comprising receiving a response from the selected database that was queried.

5. The method according to claim 4, further comprising formatting and sending a response to the customer.

6. The method according to claim 1, wherein the launching further comprises launching a query to one of the plurality of databases prior to the telephone call being connected to the called party.

7. The method according to claim 1, wherein the launching further comprises launching a query to one of the plurality of databases during the pendency of the telephone call.

8. The method according to claim 1, wherein the launching further comprises launching a query to one of the plurality of databases after the telephone call has been disconnected.

9. The method according to claim 1, wherein at least one of the plurality of databases comprises a line information database.

10. A method of identifying a subscriber's local service provider in response to a telephone call from the subscriber to a called party, the method comprising:
receiving a request from a customer for the identity of the subscriber's local service provider;
determining a message type in which to query a database based at least on a cost associated with each of a plurality of message types; and
launching a query to one of a plurality of databases based upon the determination.

11. The method according to claim 10, wherein the determination is further based upon the message type supported by each of the plurality of databases.

12. The method according to claim 10, further comprising receiving a response from the queried database.

13. The method according to claim 12, further comprising formatting and sending a response to the customer.

14. The method according to claim 10, wherein the launching further comprises launching a query to one of the plurality of databases prior to the telephone call being connected to the called party.

15. The method according to claim 10, wherein the launching further comprises launching a query to one of the plurality of databases during the pendency of the telephone call.

16. The method according to claim 10, wherein the launching further comprises launching a query to one of the plurality of databases after the telephone call has been disconnected.

17. The method according to claim 10, wherein at least one of the plurality of databases comprises a line information database.

18. A system for identifying a subscriber's local service provider associated with a telephone call from the subscriber to a called party, the system comprising:
a gateway that receives a request from a customer to ascertain the identity of the subscriber's local service provider, the gateway being able to determine one of a plurality of message types in which to query one of a plurality of databases.

19. The system according to claim 18, wherein the gateway determines the message type based upon a cost associated with each available message type.

20. The system according to claim 18, wherein the gateway determines the message type based upon a message type supported by each of the plurality of databases.

21. The system according to claim 18, wherein the request is received prior to the telephone call being connected to the called party.

22. The system according to claim 18, wherein the request is received during the pendency of the telephone call.

23. The system according to claim 18, wherein the request is received after the telephone call has been disconnected.

24. The system according to claim 18, wherein at least one of the plurality of databases comprises a line information database.

25. A computer readable medium for identifying a subscriber's local service provider in response to a telephone call from the subscriber to a called party, the computer readable medium comprising:
a receiving source code segment that receives a request from a customer for the identity of the subscriber's local service provider;
a determining source code segment that determines a message type to query a database based on a cost associated with each of a plurality of message types; and
a launching source code segment that launches a query to one of a plurality of databases.

26. The system according to claim 25, wherein at least one of the plurality of databases comprises a line information database.
